(19) United States
(12) Patent Application Publication
(10) Pub. No.: US 2013/0342536 A1
(43) Pub. Date: Dec. 26, 2013

(54) IMAGE PROCESSING APPARATUS, METHOD OF CONTROLLING THE SAME AND COMPUTER-READABLE MEDIUM

(71) Applicant: Canon Kabushiki Kaisha, Tokyo (JP)

(72) Inventor: Kaori Taya, Yokohama-shi (JP)

(21) Appl. No.: 13/909,492

(22) Filed: Jun. 4, 2013

(30) Foreign Application Priority Data
Jun. 22, 2012 (JP) 2012-141469

(51) Int. Cl. G06T 15/20

(52) U.S. Cl. CPC G06T 15/20
USPC 345/427

(57) ABSTRACT

Object information concerning an object image is input. Line-of-sight information of a viewer is input. Conversion parameters for converting for values on a coordinate system on an object image in the virtual space defined with respect to a display device into values on the coordinate system of the display device. A rendering image is created by rendering an object image based on the conversion parameters. A deformed filter is created by deforming a reference filter to be applied to the object image set at reference coordinates in a virtual space, based on the line-of-sight information and conversion parameters. The image data obtained by performing filter processing for the rendering image by using the deformed filter is output.

### BACKGROUND OF THE INVENTION

1. Field of the Invention

The present invention relates to an image processing technique which can display an image in accordance with the viewpoint of a viewer.

2. Description of the Related Art

There has been proposed a system which allows a viewer to obtain a stereoscopic image by displaying images with a binocular parallax on the left and right eyes of the viewer. Schemes for presenting different images on the left and right eyes include a scheme of mounting special eyeglasses using liquid crystal shutters, polarization plates, and the like and a scheme of using special displays using parallax barriers, lenticular lenses, and the like.

Recently, there has been proposed a system which allows a stereoscopic effect to be obtained together with a sense of realism by performing image processing in accordance with a change in the position of an observer by using viewpoint position information of the observer.

Japanese Patent Laid-Open No. 2006-318015 discloses an arrangement which provides a picture in a virtual space without making a viewer feel any feeling of strangeness by converting edge lines of a display image including at least one edge line in accordance with the viewpoint position of the viewer by using a detection unit which detects the viewpoint position of the viewer.

Japanese Patent Laid-Open No. 2006-338163 discloses an arrangement which provides a sense of virtual reality to a viewer as if he/she existed in a virtual CG space, by changing the position/posture of a CG object in accordance with the position of the viewer using a head mounted display, a position and orientation sensor, and a CG image generation unit.

The technique disclosed in Japanese Patent Laid-Open No. 2006-318015 has a problem that aliasing occurs in an image due to a change in observer position. In addition, the technique disclosed in Japanese Patent Laid-Open No. 2006-338163 is based on the premise that the relative positions of a display and viewer do not change. If, therefore, the relative positions change, the CG object seen from the observer sometimes distorts.

The present invention provides an image processing technique which can output an optimal image in accordance with the viewpoint position of an observer.

### SUMMARY OF THE INVENTION

In order to achieve the above object, an image processing apparatus according to the present invention has the following arrangement. That is, an image processing apparatus which performs image processing for displaying an object image on a display device in accordance with line-of-sight information of a viewer, the apparatus comprising: an object information input unit configured to input object information concerning the object image; a line-of-sight information input unit configured to input the line-of-sight information; a creation unit configured to create a deformed filter obtained by deforming a reference filter to be applied to the object image, based on the line-of-sight information; and a filter unit configured to perform filter processing for an object image rendered based on the line-of-sight information and the object information by using the deformed filter.

According to the present invention, it is possible to output an optimal image obtained by reducing aliasing and distortion due to filter processing for an object image in accordance with the viewpoint position of an observer.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an image processing apparatus according to the first embodiment;

FIG. 2 is a flowchart of processing by the image processing apparatus according to the first embodiment;

FIG. 3A is a perspective view for explaining coordinate conversion according to the first embodiment in the case of a three-dimensional space;

FIG. 3B is a perspective view for explaining coordinate conversion according to the first embodiment in the case of a three-dimensional space;

FIG. 3C is a perspective view for explaining coordinate conversion according to the first embodiment in the case of a three-dimensional space;

FIG. 4A is a view for explaining the creation of a filter according to the first embodiment in the case of a three-dimensional space;

FIG. 4B is a view for explaining the creation of a filter according to the first embodiment in the case of a three-dimensional space;

FIG. 5 is a flowchart of filter creation processing according to the first embodiment;

FIG. 6 is a schematic view showing processing to be performed when a screen according to the first embodiment is not one plane;

FIG. 7 is a schematic view of blur on the human eye according to the second embodiment; and

FIG. 8 is a flowchart of filter creation processing based on blur on the human eye according to the second embodiment.

### DESCRIPTION OF THE EMBODIMENTS

The embodiments of the present invention will be described in detail below with reference to the accompanying drawings.

Note that the arrangement shown in each embodiment described below is merely an example, and the present invention is not limited to the arrangement shown in the accompanying drawings.

### First Embodiment

The first embodiment is an image processing apparatus which displays the image obtained by creating a rendering image of a 3D object (object image) and performing filter processing (filtering) for the created image in accordance with the viewpoint of a viewer. This apparatus also performs the processing of deforming a filter shape as well as coordinate conversion for rendering in accordance with a viewpoint position.

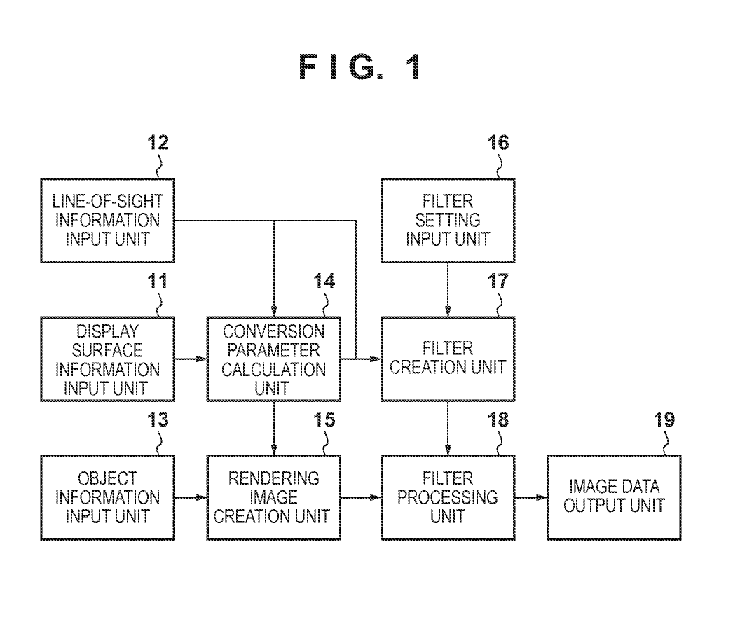

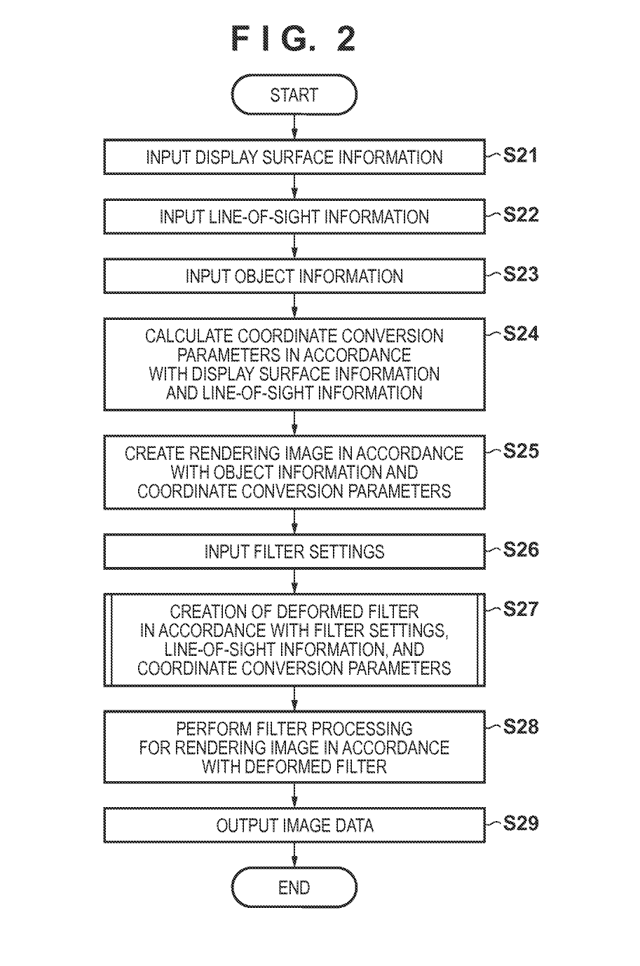

Image Processing Apparatus (FIGS. 1 and 2)

FIG. 1 shows an example of the arrangement of the image processing apparatus according to the first embodiment. FIG. 2 is a flowchart of processing by the image processing apparatus according to the first embodiment. A procedure for processing by the image processing apparatus will be described below with reference to FIGS. 1 and 2.

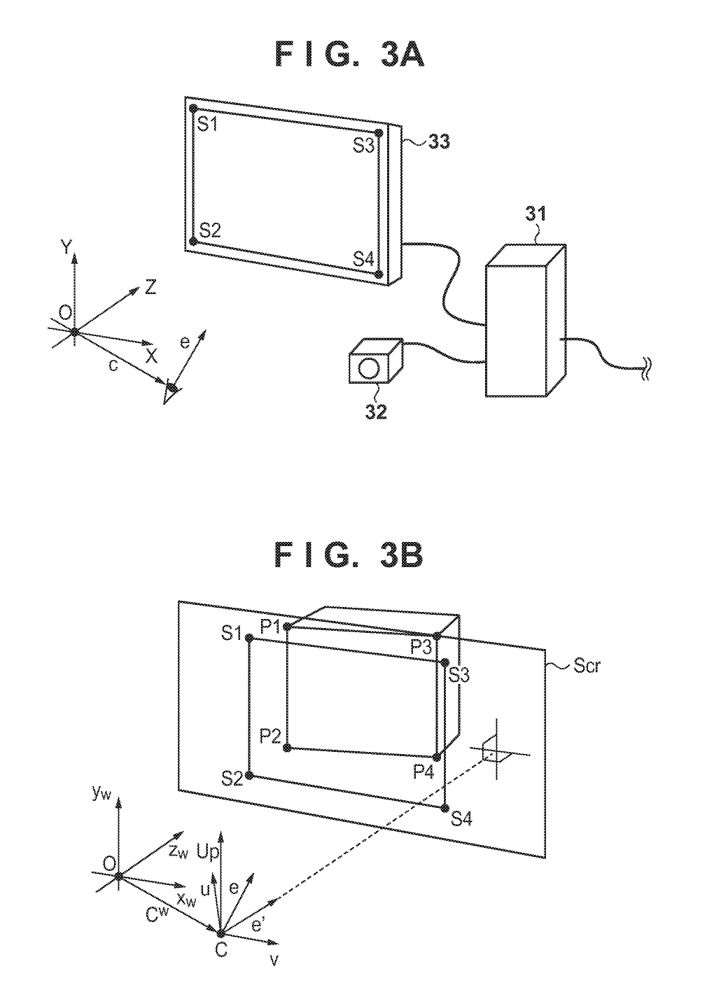

First of all, in step S21, a display surface information input unit 11 inputs the position information (to be referred to as display surface information hereinafter) of an image display surface. In this case, the image display surface is a surface on which the image data created by processing (to be described later) is actually displayed, and includes, for example, the screen of a monitor or a screen on which an image is projected by a projector. Display surface information includes, for example, the three-dimensional coordinates of the four corners (four points) of the image display surface. FIG. 3A shows an example of four points S1, S2, S3, and S4 and a screen center S0. Referring to FIG. 3A, reference numeral 31 denotes an image processing apparatus; 32, a position sensor; and 33, an image display surface. These three-dimensional coordinates are calculated by measurement with reference to a proper position as an origin O. The display surface information input unit 11 may acquire display surface information which is measured and held in advance in a storage device in the image processing apparatus.

In step S22, a line-of-sight information input unit 12 inputs line-of-sight information of the viewer. Line-of-sight information is constituted by a viewpoint position vector c representing the position of the viewer and a line-of-sight direction vector e representing the viewing direction of the viewer. FIG. 3A shows an example of these vectors. It is possible to use a position measurement technique using infrared light or electromagnetic waves used for the head mounted display described in Japanese Patent Laid-Open No. 2006-338163 to acquire the viewpoint position vector c and the line-of-sight direction vector e. Alternatively, the apparatus may detect the positions of the left and right pupils of the viewer by image processing and calculate the coordinates of the midpoint between the two pupils as a viewpoint position vector c and a vector directing toward the image display surface perpendicular to a line connecting the two pupils as a line-of-sight direction vector e. It is possible to acquire the positions of the pupils by combining an existing face detection technique with a three-dimensional position estimation technique.

In step S23, an object information input unit 13 inputs vertex data as object information concerning an object (object image) in a virtual three-dimensional space and object information formed from texture information. Object information includes, for example, material information describing the reflection characteristic of an object and the like and light source information in a virtual three-dimensional space.

In step S24, a conversion parameter calculation unit 14 calculates various types of coordinate conversion parameters to be used for vertex processing at the time of rendering by using display surface information and line-of-sight information. Coordinate conversion performed in vertex processing includes view conversion and projection conversion. The conversion parameter calculation unit 14 converts the vertex coordinates of an object from values in a virtual three-dimensional space (origin O) to values on a view coordinate system with the position of the virtual camera being an origin by view conversion. The conversion parameter calculation unit 14 then converts the vertex coordinates represented by the view coordinate system into values in the projection coordinate system which are coordinates on a screen plane Scr by projection conversion. Coordinate conversion parameters used for view conversion and projection conversion will be described below.

View Conversion (FIG. 3B)

In view conversion, coordinates (x_{w}, y_{w}, z_{w}) in a virtual three-dimensional space are generally converted into view coordinates (xᵥ, yᵥ, zᵥ) by the matrix calculation represented by equation (1):

$$( \begin{matrix}{x}_{v} \\ {y}_{v} \\ {z}_{v} \\ 1\end{matrix} ) = {M}_{v} ( \begin{matrix}{x}_{w} \\ {y}_{w} \\ {z}_{w} \\ 1\end{matrix} ) \qquad ( 1 )$$

In equation (1), Mᵥ is the view conversion matrix represented by equation (2) given below:

$${M}_{v} = ( \begin{matrix}{v}_{x} & {v}_{y} & {v}_{z} & 0 \\ {u}_{x} & {u}_{y} & {u}_{z} & 0 \\ {e}_{x}^{′} & {e}_{y}^{′} & {e}_{z}^{′} & 0 \\ 0 & 0 & 0 & 1\end{matrix} ) ( \begin{matrix}1 & 0 & 0 & - {C}_{x}^{w} \\ 0 & 1 & 0 & - {C}_{y}^{w} \\ 0 & 0 & 1 & - {C}_{z}^{w} \\ 0 & 0 & 0 & 1\end{matrix} ) \qquad ( 2 )$$

In this equation, v=(vₓ, v_{y}, v_{z})^{T}, u=(uₓ, u_{y}, u_{z})^{T}, and e′=(e′ₓ, e′_{y}, e′_{z})^{T} are unit vectors representing the lateral direction, upper direction, and line-of-sight direction of a virtual camera. C^{w}=(C^{w}ₓ, C^{w}_{y}, C^{w}_{z})^{T} in equation (2) represents a position vector of the virtual camera. In this case, the first matrix is a matrix for base conversion, and the second matrix is a matrix for origin shift.

In general, when performing rendering upon matching the virtual camera with the position of the viewer, a position C of the virtual camera is matched with the position of the viewer. The line-of-sight direction vector e′ of the virtual camera is matched with the line-of-sight direction vector e of the viewer based on the assumption that the line-of-sight direction vector e of the viewer is perpendicular to the screen surface.

In the first embodiment, however, the line-of-sight direction vector e of the viewer is oblique to the screen surface. In the first embodiment, although the position C of the virtual camera is matched with the position of the viewer as usual, the line-of-sight direction vector e′ of the virtual camera is a vector perpendicular to the screen surface passing through the position of the viewer. FIG. 3B shows an example of the position C of the virtual camera, the line-of-sight direction vector e′, a lateral direction vector v, and an upper direction vector u. In this case, reference symbol Uₚ^{w} denotes the vertical direction of the ground in a virtual three-dimensional space. It is possible to calculate the lateral direction vector v as v=Uₚ^{w} x e/|Uₚ^{w}×e| from the outer product of Uₚ^{w} and the line-of-sight direction vector e. It is also possible to calculate the upper direction vector u as u=e×v/|e×v| from the outer product of the line-of-sight direction vector e and the lateral direction vector v. A view conversion matrix Mᵥ calculated by equation (2) under the above conditions is a coordinate conversion parameter in view conversion in the first embodiment.

Projection Conversion (FIG. 3C)

In projection conversion, view coordinates (xᵥ, yᵥ, zᵥ) are converted into the projection coordinates (xₚ, yₚ, zₚ) according to equation (3) given below:

$$( \begin{matrix}{x}_{p} \\ {y}_{p} \\ {z}_{p} \\ 1\end{matrix} ) = {M}_{S} {M}_{t} {M}_{p} ( \begin{matrix}{x}_{v} \\ {y}_{v} \\ {z}_{v} \\ 1\end{matrix} ) \qquad ( 3 )$$

In equation (3), Mₚ is the projection conversion matrix represented by equation (4):

$${M}_{p} = \frac{1}{{z}_{v}} ( \begin{matrix}\frac{1}{{A}_{R} tan ( {θ}_{FOV} / 2 )} & 0 & 0 & 0 \\ 0 & \frac{1}{tan ( {θ}_{FOV} / 2 )} & 0 & 0 \\ 0 & 0 & \frac{{z}_{f}}{{z}_{f} - {z}_{n}} & - \frac{{z}_{n} {z}_{f}}{{z}_{f} - {z}_{n}} \\ 0 & 0 & 1 & 0\end{matrix} ) \qquad ( 4 )$$

In this case, θ_{FOV} is the horizontal angle of view of the virtual camera, and A_{R} is the aspect ratio (=horizontal field-of-view size W÷vertical field-of-view size H) of the virtual camera. In general, when the virtual camera faces the image display surface (an extension of the line-of-sight direction vector e′ of the virtual camera vertically intersects the center of the image display surface), the horizontal angle of view θ_{FOV} and aspect ratio A_{R} of the virtual camera are set in accordance with the width W and height H of the image display surface and the distance d to the screen plane Scr.

However, the virtual camera in the first embodiment does not always face the image display surface of the virtual camera. In the first embodiment, therefore, the horizontal angle of view θ_{FOV} of the virtual camera is set to a value which includes the image display surface on the screen plane Scr. More specifically, let Wmax and Hmax be values twice the distances from the virtual camera to points, of the four corner points of of the image display surface, to which the distances from the virtual camera in the xv-axis direction and yv-axis directions are largest, respectively. The horizontal angle of view θ_{FOV} is set to make the respective values fall within 2*d*A_{R}*tan (θ_{FOV}/2) and 2*d*tan (θ_{FOV}/2), respectively. FIG. 3C shows an example of the horizontal angel of view θ_{FOV}, horizontal field-of-view size Wmax, and vertical field-of-view size Hmax.

In equation (3) given above, Mₜ is the conversion matrix of the origin position and scale represented by equation (5) given below:

$${M}_{t} = ( \begin{matrix}\frac{2}{{W}^{p}} & 0 & 0 & 0 \\ 0 & \frac{2}{{H}^{P}} & 0 & 0 \\ 0 & 0 & 1 & 0 \\ 0 & 0 & 0 & 1\end{matrix} ) ( \begin{matrix}1 & 0 & 0 & {S}_{0 x}^{p} \\ 0 & 1 & 0 & {S}_{0 y}^{p} \\ 0 & 0 & 1 & 0 \\ 0 & 0 & 0 & 1\end{matrix} ) \qquad ( 5 )$$

In this case, W^{p}, H^{p}, S₀ₓ^{p}, and S_{0y}^{p} are represented by equation (6) given below:

$${W}^{P} = \frac{W}{{A}_{R} tan ( {θ}_{FOV} / 2 ) d} , {H}^{P} = \frac{H}{tan ( {θ}_{FOV} / 2 ) d} , \\ ( \begin{matrix}{S}_{0 x}^{p} \\ {S}_{0 y}^{p} \\ {S}_{0 z}^{p} \\ 1\end{matrix} ) = {M}_{p} {M}_{v} ( \begin{matrix}{S}_{0 x}^{w} \\ {S}_{0 y}^{w} \\ {S}_{0 z}^{w} \\ 1\end{matrix} ) \qquad ( 6 )$$

In this case, S₀^{w}=(S₀ₓ^{w}, S_{0y}^{w}, S_{0z}^{w})^{T} represents the coordinates of the screen center S0 (see FIG. 3C) as the screen center in the virtual three-dimensional space. If the line-of-sight direction vector e is perpendicular to the screen, W^{p}=H^{p}=2, and the first scale conversion matrix is a unit matrix.

In equation (3) given above, Mₛ represents a matrix for scale conversion to the screen coordinate system and origin shift represented by equation (7) given below:

$${M}_{s} = ( \begin{matrix}\frac{{W}^{S}}{2} & 0 & 0 & \frac{{W}^{S}}{2} \\ 0 & - \frac{{H}^{S}}{2} & 0 & \frac{{H}^{S}}{2} \\ 0 & 0 & 1 & 0 \\ 0 & 0 & 0 & 1\end{matrix} ) \qquad ( 7 )$$

In this case, W^{s} and H^{s} represent the horizontal and vertical lengths of a drawing unit on the screen. For example, setting the numbers of pixels in the horizontal and vertical directions can perform conversion to a pixel coordinate system having an origin at an upper left position on the screen.

The conversion parameter calculation unit 14 stores the above view conversion matrix Mᵥ and projection conversion matrices Mₚ, Mₜ, and Mₛ as coordinate conversion parameters.

In step S25, a rendering image creation unit 15 then executes rendering by using object information and coordinate conversion parameters to create a rendering image. More specifically, the rendering image creation unit 15 performs vertex processing by using the view conversion matrix Mᵥ and a projection conversion matrices Mₛ, Mₜ, and Mₚ. The rendering image creation unit 15 then may output a rendering image by projecting an object on the screen plane Scr and performing pixel processing such as texture mapping.

In step S26, a filter setting input unit 16 inputs filter settings for a reference filter as a filter to be applied to the object. In this case, filter settings include, for example, a filter type for blurring, sharpness, or the like, a filter size, and a coefficient.

Note that when changing filter settings in accordance with the depth of the object, it may be possible to provide depth information by using the z-coordinate of the image obtained by rendering in step S25. In this case, the z-coordinate depth information is scaled according to 0≦z≦1 by equation (4), and hence may be converted into a view conversion coordinate by

$${z}^{v} = \frac{{z}_{f} {z}_{n}}{{z}_{f} ( 1 - {z}^{p} )} \qquad ( 8 )$$

In step S27, a filter creation unit 17 creates a filter (to be referred to as a deformed filter hereinafter) which is deformed in accordance with filter settings, line-of-sight information, and coordinate conversion parameters. A method of deforming a filter will be described later.

In step S28, a filter processing unit 18 performs filter processing of the rendering image in accordance with the deformed filter.

Lastly, in step S29, an image data output unit 19 outputs the image data obtained by performing filter processing of the rendering image.

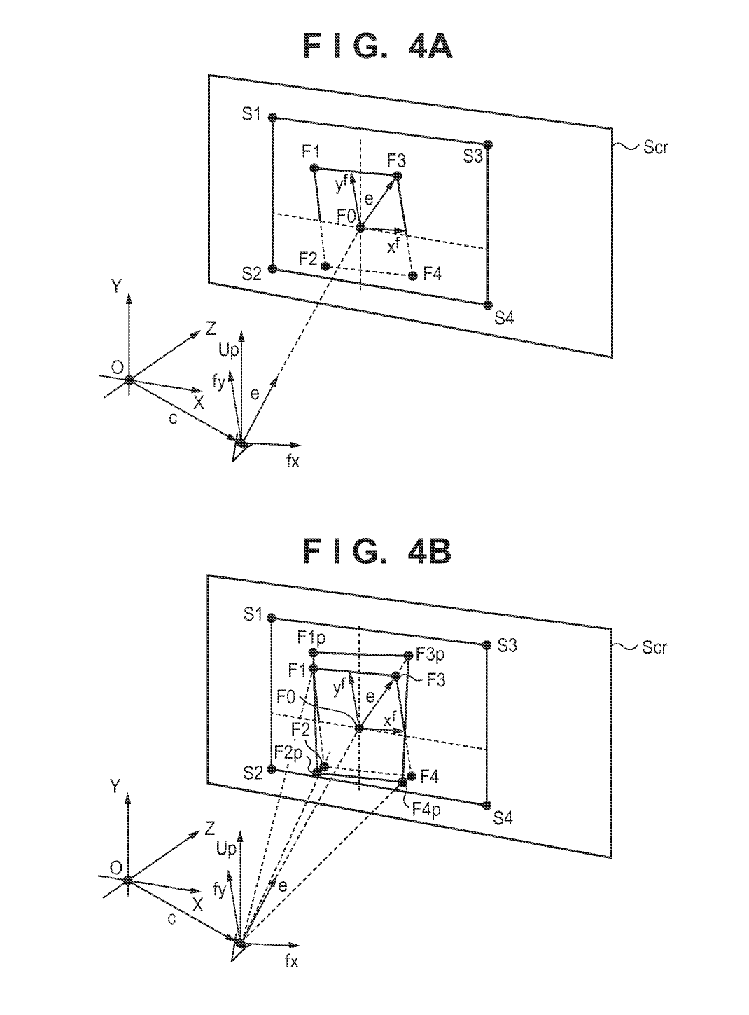

Creation of Deformed Filter (FIG. 5)

The creation of a deformed filter by the filter creation unit 17 in step S27 will be described in detail with reference to FIG. 5. The following is a case in which the filter in the first embodiment is set so as not to deform the shape of an object when viewed from the line-of-sight direction.

In step S51, the filter creation unit 17 creates a filter in accordance with filter settings. In this case, let f(x, y) be a filter coefficient when the filter center is set as x=0 and y=0. An example of a filter coefficient includes that of a Gaussian filter and Laplacian filter.

In step S52, the filter creation unit 17 sets an x-direction vector x^{f}, a y-direction vector y^{f}, and origin coordinates F0^{w} of the filter. In this case, for the line-of-sight direction vector e, x^{f} and y^{f} may be set by

$${x}^{f} = \frac{e \times Up}{\vert e \times Up \vert} , {y}^{f} = \frac{{x}^{f} \times e}{\vert {x}^{f} \times e \vert} \qquad ( 9 )$$

In addition, assume that the origin of a filter (filter coordinates) is a gaze point on the screen, that is, an intersection point F0 between the line-of-sight direction vector e and the screen plane Scr. In addition, the coordinates (reference coordinates) of the intersection point F0 in a virtual space are represented by F0^{w}=(F₀ₓ^{w}, F_{0y}^{w}, F_{0z}^{w})_{T}. Assume that a filter size is set in advance with reference to a filter size with F0. That is, a filter size at the position represented by z=d with view coordinates is a set value as a filter size. If a filter size is set at a different z-coordinate z′, a filter may be set by multiplying the filter size by d/z′ in step S51.

In step S53, the filter creation unit 17 calculates a conversion matrix M_{fw} from filter coordinates to virtual space coordinates. In this case, since it is possible to calculate a conversion matrix M_{f} from virtual space coordinates to filter coordinates according to equations (10), (11), and (12) as in the case of object conversion, M_{fw}=M_{f}⁻¹ may be set according to an inverse matrix of the above matrix.

$$\begin{matrix} ( \begin{matrix}{x}_{f} \\ {y}_{f} \\ {z}_{f} \\ 1\end{matrix} ) = {M}_{f} ( \begin{matrix}{x}_{w} \\ {y}_{w} \\ {z}_{w} \\ 1\end{matrix} ) = {M}_{fp} {M}_{fv} ( \begin{matrix}{x}_{w} \\ {y}_{w} \\ {z}_{w} \\ 1\end{matrix} ) , \\ ( \begin{matrix}{x}_{fv} \\ {y}_{fv} \\ {z}_{fv} \\ 1\end{matrix} ) = {M}_{fv} ( \begin{matrix}{x}_{w} \\ {y}_{w} \\ {z}_{w} \\ 1\end{matrix} ) & ( 10 ) \\ {M}_{fv} = ( \begin{matrix}{x}_{x}^{f} & {x}_{y}^{f} & {x}_{z}^{f} & 0 \\ {y}_{x}^{f} & {y}_{y}^{f} & {y}_{z}^{f} & 0 \\ {e}_{x} & {e}_{y} & {e}_{z} & 0 \\ 0 & 0 & 0 & 1\end{matrix} ) ( \begin{matrix}1 & 0 & 0 & - {F}_{0 x}^{w} \\ 0 & 1 & 0 & - {F}_{0 y}^{w} \\ 0 & 0 & 1 & - {F}_{0 z}^{w} \\ 0 & 0 & 0 & 1\end{matrix} ) & ( 11 ) \\ {M}_{fp} = \frac{1}{{z}_{fv}} ( \begin{matrix}\frac{{W}_{f}}{2 {A}_{Rf} tan ( {θ}_{FOVf} / 2 )} & 0 & 0 & 0 \\ 0 & \frac{{H}_{f}}{2 tan ( {θ}_{FOVf} / 2 )} & 0 & 0 \\ 0 & 0 & - \frac{{z}_{f}}{{z}_{f} - {z}_{n}} & - \frac{{z}_{n} {z}_{f}}{{z}_{f} - {z}_{n}} \\ 0 & 0 & 1 & 0\end{matrix} ) & ( 12 )\end{matrix}$$

In this case, the vertical size and horizontal size of the filter are represented by H_{f} and W_{f}, A_{Rf}=W_{f}/H_{f}, and θ_{FOVf} is set to 2*atan(H_{f}/2d). In addition, z-coordinates on the filter are calculated from z-coordinates represented by x_{f}*x^{f}+y_{f}*y^{f}+F0^{w}.

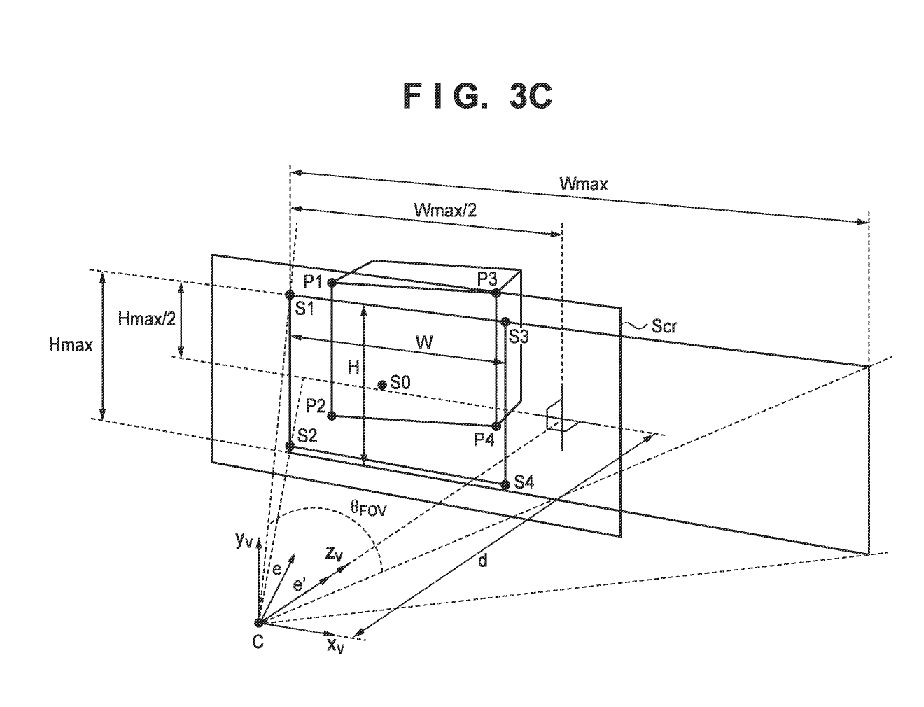

In step S54, the filter creation unit 17 projects the origin F0^{w} of the filter coordinate system and the filter coordinates of end points of the filter coordinate system on the screen coordinate system. In this case, the filter coordinates of the end points are F1=(−2/W, 2/H), F2=(−2/W, −2/H), F3=(2/W, 2/H), and F4=(2/W, 2/H) shown in FIG. 4A. The points on the screen coordinate system on which these points are projected are F1p, F2p, F3p, and F4p shown in FIG. 4B. A conversion matrix may be given as MₛMₜMₚMᵥM_{fw} by using M_{fw} calculated in step S52 and the conversion parameters Mᵥ, Mₚ, Mₜ, and Mₛ calculated in step S24. Assume that Mᵢ=MₛMₜMₚMᵥ. This makes it possible to calculate a filter size (filter area) on the screen coordinate system.

In step S55, the filter creation unit 17 converts all the pixels in the region (filter area) surrounded by the end points of the filter converted in the screen coordinate system into filter coordinates. This processing is matrix conversion in the inverse direction in FIG. 53, and hence the filter creation unit 17 may multiply the coordinates by an inverse matrix M_{f}Mᵢ⁻¹ of the conversion matrix used in step S53.

In step S56, the filter creation unit 17 calculates a Jacobian for each point converted from filter coordinates to screen coordinates. This processing is required for variable conversion of an integral function such as a filter function. The processing is performed because irregular density occurs due to x- and y-coordinates upon conversion from points uniformly distributed on the screen coordinate system into filter coordinates. For this processing, assume that p_{x,y}=(x, y)+MᵢM_{fw}F0^{w} based on an origin F0^{w} converted on the screen coordinate system upon calculation of Jacobians. At this time, the following equation may be established by using P_{x,y} and its adjacent points represented by P_{x+1,y}=(x+1, y)+MᵢM_{fw}F0^{w} and P_{x,y+1}=(x, y+1)+MᵢM_{fw}F0^{w}:

|J(x, y)|=∥(M_{f}Mᵢ⁻¹P_{i+1,y}−M_{f}Mᵢ⁻¹P_{x,y})×(M_{f}Mᵢ⁻¹P_{x,y+1}−M_{f}Mᵢ⁻¹P_{x,y})∥ (13)

Note that the z-coordinate of the point P_{x,y} is represented by zf(d−zn)/(zf−zn) by using a distance d from the screen plane Scr to a viewpoint position. The resultant area is twice (parallelogram) the area of the triangle defined by the converted points. Although this is a discrete and simple calculation method, the above coordinates may be analytically calculated in the form of the derivative of continuous functions.

Lastly, in step S57, the filter creation unit 17 calculates fₜᵣₐₙₛ(x, y) as a deformed filter coefficient f_{new}(x, y) by multiplying the points converted into filter coordinates by the reciprocals of the Jacobians according to equation (14):

$${f}_{trans} ( x , y ) = f ( {x}^{′} , {y}^{′} ) \vert J ( x , y ) \vert , ( \begin{matrix}{x}^{′} \\ {y}^{′} \\ {z}^{′} \\ 1\end{matrix} ) = {M}_{f} {M}_{i}^{- 1} ( \begin{matrix}x \\ y \\ z \\ 1\end{matrix} ) \qquad ( 14 )$$

With the above processing, for example, a true circular filter is deformed into an elliptic filter which is horizontally long when viewed from an oblique direction, and filter coefficients can be set such that the shape of the filter remains the same even with a change in viewpoint position.

As described above, according to the first embodiment, it is possible to perform rendering and filter processing for a 3D object with no distortion and less aliasing when the viewer views the image display surface from his/her position, even if the position of the viewer changes.

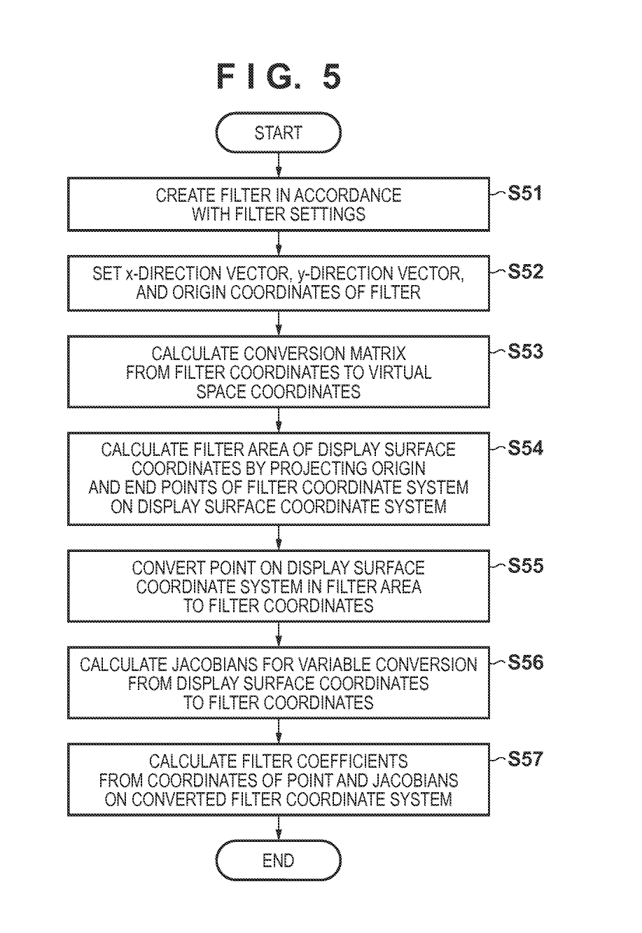

The first embodiment has exemplified the case in which the screen is one plane. Even if, however, the screen includes a plurality of planes or is a curved surface, it is possible to perform the same processing by performing the same processing for each plane divided from the screen regarded as a set of small screens (planes) as shown in FIG. 6.

In addition, the first embodiment has exemplified the case of the conversion of a 3D object. However, an object may be a 2D image or vector data.

Furthermore, although the arrangement of the first embodiment may include various constituent elements other than those described above, since they are irrelevant to the spirit of the present invention, a description of them will be omitted.

### Second Embodiment

The second embodiment will exemplify an arrangement configured to create a filter by using gaze point information as the coordinates of the gaze point of a viewer in consideration of blur on the eye of the viewer himself/herself, in addition to the arrangement of the first embodiment.

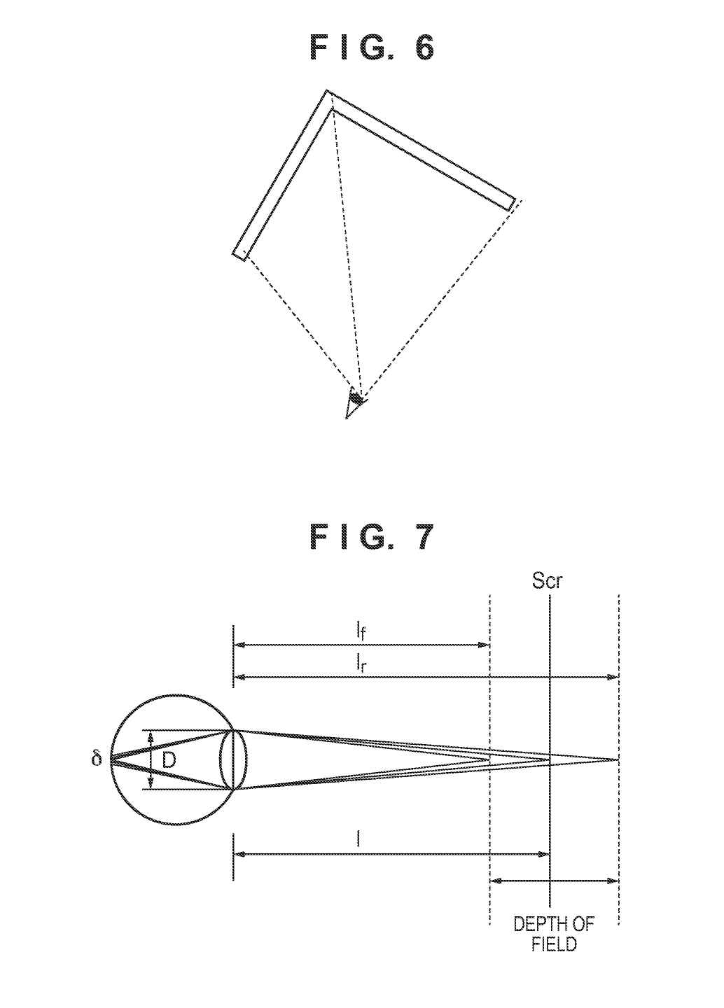

It is known that a camera lens has an index representing the degree of blur in accordance with a depth called a depth of field. The human eye is also a lens, and hence has a depth of field. FIG. 7 is a view for explaining the depth of field of the human eye. Referring to FIG. 7, reference symbol l denotes a focal length; lᵣ, a forward depth of field; and l_{f}, a backward depth of field. These data represent the two ends of a distance range in which blur is equal to or less than an allowable blur amount δ. It is possible to calculate lᵣ and l_{f}, by using a pupil diameter D, an eye lens focal length f, l, and δ, as

$${l}_{r} = \frac{1}{1 + δ l / fD} l , {l}_{f} = \frac{1}{1 - δ l / fD} l \qquad ( 15 )$$

In contrast, it is possible to calculate a blur amount δ_{vf} at view coordinates (x_{vf}, y_{vf}, z_{vf}) of the filter represented by equation (10), with the origin being a view position when the z-coordinate of a gaze point is represented by 1, according to

$${δ}_{vf} = fD \vert \frac{1}{{z}_{vf}} - \frac{1}{l} \vert \qquad ( 16 )$$

If this blur is large, the viewer views the image processing result obtained in the first embodiment with different blur amounts depending on screen positions. It therefore can be to create a filter by using these blur amounts to allow the viewer to uniformly view the image processing result.

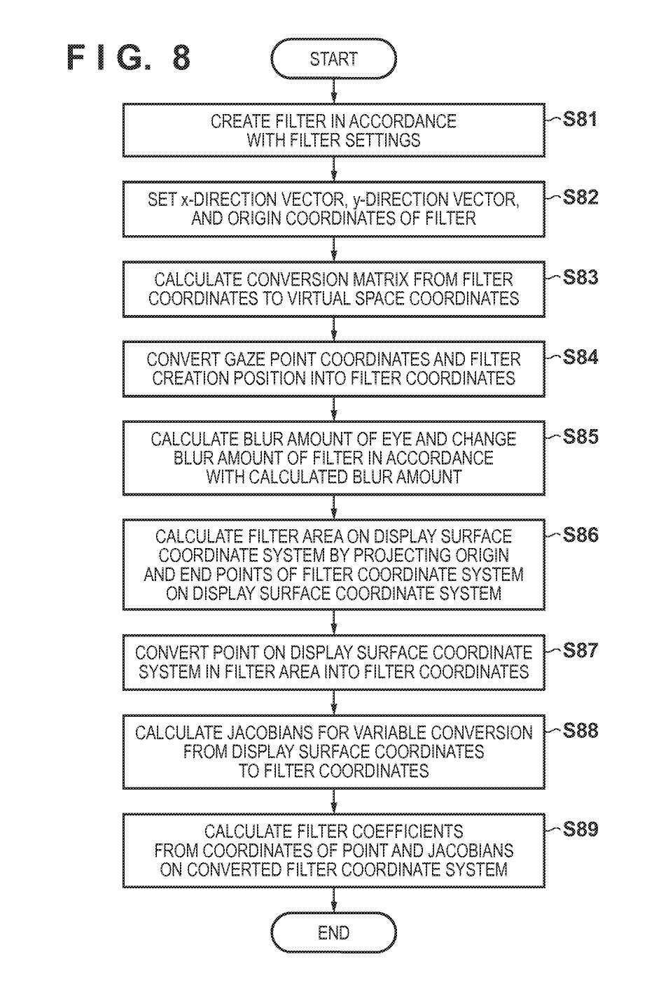

A procedure in which a filter creation unit 17 creates a filter in consideration of the blur amount of the eye will be described with reference to FIG. 8.

Steps S81 to S83 correspond to steps S51 to S53 in FIG. 5, and the processing contents in these steps are the same. A description of them will therefore be omitted.

In step S84, the filter creation unit 17 converts gaze point coordinates and a filter creation position into filter coordinates. In this case, gaze point coordinates P0 are coordinates in a virtual space, and a filter creation position P1 has coordinates on the screen. In this case, letting P0=(x0_{w}, y0_{w}, z0_{w}) and P1=(x1ₚ, y1ₚ, z1ₚ), the position and the coordinates can be converted according to

$$( \begin{matrix}x {0}_{vf} \\ y {0}_{vf} \\ z {0}_{vf} \\ 1\end{matrix} ) = {M}_{fv} ( \begin{matrix}x {0}_{w} \\ y {0}_{w} \\ z {0}_{w} \\ 1\end{matrix} ) , ( \begin{matrix}x {1}_{vf} \\ y {1}_{vf} \\ z {1}_{vf} \\ 1\end{matrix} ) = {M}_{fv} {M}_{i}^{- 1} ( \begin{matrix}x {1}_{p} \\ y {1}_{p} \\ z {1}_{p} \\ 1\end{matrix} ) \qquad ( 17 )$$

In step S85, the filter creation unit 17 calculates the blur amount of the eye and changes the blur amount (weight) of the filter in accordance with the calculated blur amount. In this case, the filter creation unit 17 calculates a blur amount δ_{vf} of the eye by using equations (16) and (17) according to equation (18):

$${δ}_{vf} = fD \vert \frac{1}{z {1}_{vf}} - \frac{1}{z {0}_{vf}} \vert \qquad ( 18 )$$

A filter f(x, y) may be set again with δ-δ_{vf} representing the blur amount of the filter. Note however that if δ-δ_{vf} is equal to or less than 0, the apparatus may prevent the image from blurring or sharpen it.

Since steps S86 to S89 correspond to steps S54 to S57 in FIG. 5, a description of them will be omitted. Note however that the filter and the domain (filter area) are those set again in step S85.

As has been described above, the second embodiment can obtain the same effects as those of the first embodiment even if the blur of the eye of the viewer himself/herself is large.

Note that the above image processing apparatus may incorporate a computer. The computer includes a main control unit such as a CPU, a ROM (Read Only Memory), a RAM (Random Access Memory), and a storage unit such as an HDD (Hard Disk Drive). The computer also incudes input and output units such as a keyboard, a mouse, and a display or touch panel and a communication unit such as a network card. These constituent elements are connected to each other via a communication path like a bus, and the main control unit executes programs stored in the storage unit, thereby implementing the function of the image processing apparatus described above.

Embodiments of the present invention can also be realized by a computer of a system or apparatus that reads out and executes computer executable instructions recorded on a storage medium (for example, non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-141469, filed Jun. 22, 2012, which is hereby incorporated by reference herein in its entirety.

What is claimed is:

1. An image processing apparatus which performs image processing for displaying an object image on a display device in accordance with line-of-sight information of a viewer, the apparatus comprising:
an object information input unit configured to input object information concerning the object image;
a line-of-sight information input unit configured to input the line-of-sight information;
a creation unit configured to create a deformed filter obtained by deforming a reference filter to be applied to the object image, based on the line-of-sight information; and
a filter unit configured to perform filter processing for an object image rendered based on the line-of-sight information and the object information by using the deformed filter.

2. The apparatus according to claim 1, further comprising:
a display screen information input unit configured to input display screen information as position information of an image display screen of the display device; and
a conversion parameter calculation unit configured to calculate a conversion parameter for converting a value on a coordinate system on the object image in a virtual space defined with respect to the display device into a value on a coordinate system of the display device,
wherein said conversion parameter calculation unit calculates the conversion parameter based on the display screen information, and
said creation unit creates a deformed filter obtained by deforming a reference filter which is set with respect to reference coordinates in the virtual space based on the line-of-sight information and the conversion parameter.

3. The apparatus according to claim 2, wherein said display screen information input unit inputs, as the display screen information, display screen information concerning each of a plurality of planes divided from the image display screen.

4. The apparatus according to claim 1, wherein said line-of-sight information input unit inputs, as the line-of-sight information, gaze point information as coordinates indicating a gaze point of the viewer on an image display screen of the display device, and
said creation unit changes a weight of the reference filter in accordance with the gaze point information.

5. A method of controlling an image processing apparatus which performs image processing for displaying an object image on a display device in accordance with line-of-sight information of a viewer, the method comprising:
an object information input step of inputting object information concerning the object image;
a line-of-sight information input step of inputting the line-of-sight information;
a creation step of creating a deformed filter obtained by deforming a reference filter to be applied to the object image, based on the line-of-sight information; and
a filter step of performing filter processing for an object image rendered based on the line-of-sight information and the object information by using the deformed filter.

6. A computer-readable medium storing a program for causing a computer to function to control an image processing apparatus which performs image processing for displaying an object image on a display device in accordance with line-of-sight information of a viewer, the program causing the computer to function as
an object information input unit configured to input object information concerning the object image,
a line-of-sight information input unit configured to input the line-of-sight information,
a creation unit configured to create a deformed filter obtained by deforming a reference filter to be applied to the object image, based on the line-of-sight information, and
a filter unit configured to perform filter processing for an object image rendered based on the line-of-sight information and the object information by using the deformed filter.
